(19) United States
(12) Patent Application Publication
(10) Pub. No.: US 2013/0241426 A1
(43) Pub. Date: Sep. 19, 2013

(54) LED LIGHT COMPRISING AN INTEGRATED DRIVER

(71) Applicants: Alexander Dohn, Memmelsdorf (DE); Christian Schnagl, Hochstadt (DE); Alfred Thimm, Wunsiedel (DE); Karl Degelmann, Marktredwitz (DE); Ewald Sutor, Oberpframmen (DE)

(72) Inventors: Alexander Dohn, Memmelsdorf (DE); Christian Schnagl, Hochstadt (DE); Alfred Thimm, Wunsiedel (DE); Karl Degelmann, Marktredwitz (DE); Ewald Sutor, Oberpframmen (DE)

(73) Assignee: CeramTec GmbH, Plochingen (DE)

(21) Appl. No.: 13/879,098

(22) PCT Filed: Oct. 14, 2011
(86) PCT No.: PCT/EP2011/067962

§ 371 Date: Jun. 3, 2013

(30) Foreign Application Priority Data
Oct. 15, 2010 (DE) 10 2010 042 485.4
Jan. 7, 2011 (DE) 10 2011 008 065.1
Jan. 7, 2011 (DE) 10 2011 012 672.4
Apr. 8, 2011 (DE) 10 2011 016 502.9

(51) Int. Cl. H05B 33/08

(52) U.S. Cl. CPC H05B 33/0854
USPC 315/200 R; 315/309

(57) ABSTRACT

Disclosed is an LED light comprising at least one LED (43) that is arranged on a ceramic support element (32) and is connected thereto in a thermally conducting manner, and an electronic driver (17) that is electrically connected to the LED (43) to supply power and control the power supplied to the LED (43). The driver (17) is connected in a thermally conducting manner to the support element (32) in order to improve the electric control function and performance of the LED (43) in the light.

The invention relates to an LED lamp having at least one LED arranged on a ceramic substrate and connected to the latter in a thermally conducting manner and having an electronic driver electrically connected to the LED to increase the power and the power supply to the LED.

LEDs are light-emitting diodes, the respective electronic driver circuits or driver modules which cause the respective LEDs to light up being known as LED drivers.

The brightness of an LED increases with the power consumption. At a constant semiconductor temperature, the increase is approximately proportional. The efficiency drops with an increase in temperature, so the light yield or luminous efficiency declines at the power limit, depending on the type of cooling. The LED will fail when the temperature of the semiconductor exceeds a maximum of about 150° C.

The power of lamps with LEDs may be controlled, for example, by resistance elements or by phase control dimmers. These drivers are always located some distance away from the actual LED, i.e., they are not in the lamp itself. One disadvantage here is that the control of the LED is sluggish due to the distance of the driver from the LED.

LEDs with a high luminous power become so hot during operation that they must be cooled to prevent them from failing.

WO 2007/107601 A1 proposes that for cooling LEDs, they should be arranged on ceramic substrate bodies which are joined in one piece to ceramic heat-dissipating cooling elements, so-called heat sinks. The conductors are applied to the substrate body, so that the substrate body is designed as a circuit board. However, what is special about this is that sintered metallized areas are applied as conductors to the surface of the substrate body. The LEDs are soldered onto the conductors. An extremely high dissipation of heat is therefore achieved and can be adjusted in a variable manner through the choice of the ceramic.

The object of the present invention is to improve the electric control and power of the LEDs.

The LED lamp according to the invention is defined by the features of patent claim 1. Thus at least one LED is arranged on a ceramic substrate body, the driver being connected to the substrate body in a manner that conducts heat. Due to the thermally conducting connection, the driver can react directly to changes in temperature of the LED. The driver is preferably designed to regulate the power supply to the LED as a function of the temperature of the substrate body and thus as a function of the temperature of the LED. When the term “driver” is used below, it is always understood to refer to an electric driver circuit.

The ceramic substrate body may have sintered metallized areas designed as conductors on its surface. The LEDs are preferably soldered to the conductors. The driver together with the LED can be soldered to the substrate body with sintered metallized areas. The driver is preferably arranged in the immediate vicinity of and/or in proximity to the LED. In an alternative embodiment, the driver is accommodated in an electronic module which is directly in the lamp in the immediate vicinity of the LEDs.

In one embodiment, the present invention thus describes a ceramic lamp with a driver as a power module in the immediate vicinity of the LED, mounted directly on the ceramic of the substrate body. Fluctuations in temperature are detected immediately as a change in light emission. The driver is preferably designed in three parts and miniaturized and has a preliminary stage (alternating current to low-voltage direct current), a temperature-controlled dimmer stage (direct current) and an output stage for the power supply to the LED. The substrate body preferably comprises a lamp fixture, such as E27, E26, GU10 or E14, for example. The driver is preferably placed directly near the LED.

If the temperature of the LED and/or its immediate environment changes, the brightness of the LED will follow the temperature immediately. Dropping temperatures on the driver (due to wind, shade, reduced radiation) will usually lead to a higher light emission. The control speed can be increased further by using a highly heat-conducting ceramic as a substrate of the LED and its driver and can be decreased by using ceramics that are poor conductors, such that the natural (unamplified) fluctuations in brightness are in inverse ratio to the thermal conductivity of the ceramic. Thus, by connecting lamps in series with individual triggering, it is possible to obtain brightness effects in a lamp array, which then make flow effects visible, for example.

Exemplary embodiments of the invention are explained in greater detail below on the basis of the figures, in which:

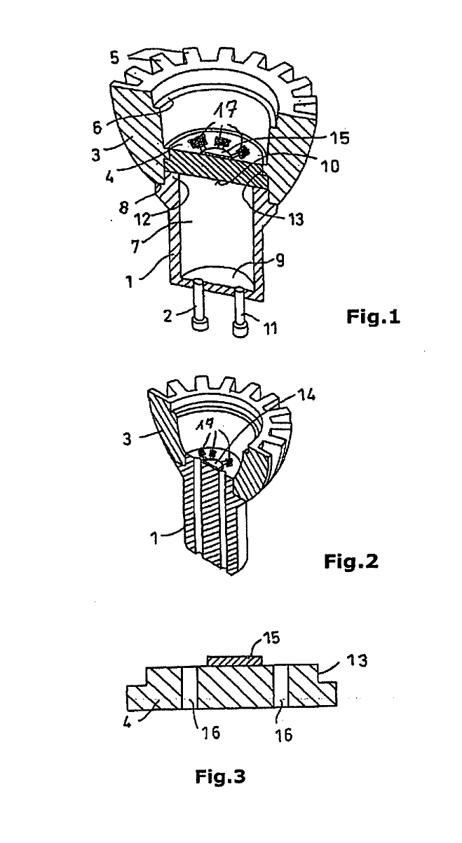

FIG. 1 shows a section through a first exemplary embodiment,

FIG. 2 shows a section through a second exemplary embodiment,

FIG. 3 shows a detail according to FIG. 2,

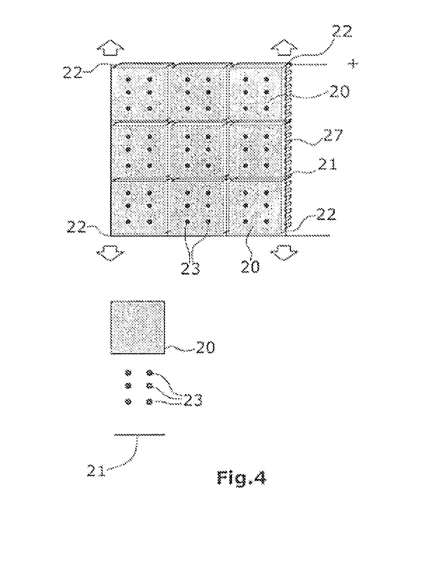

FIG. 4 shows another exemplary embodiment,

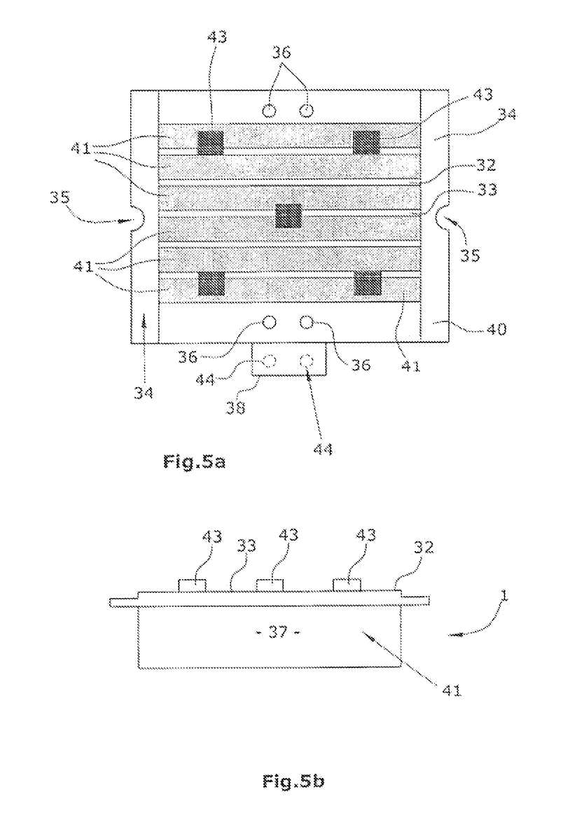

FIGS. 5a, 5b show another exemplary embodiment,

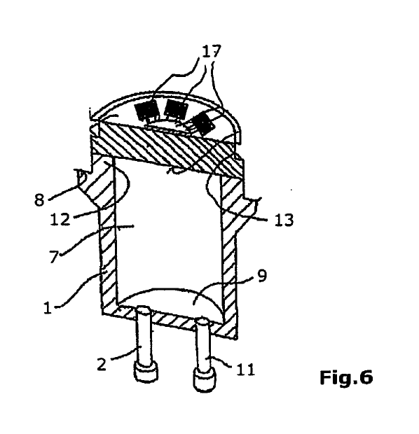

FIG. 6 shows another exemplary embodiment,

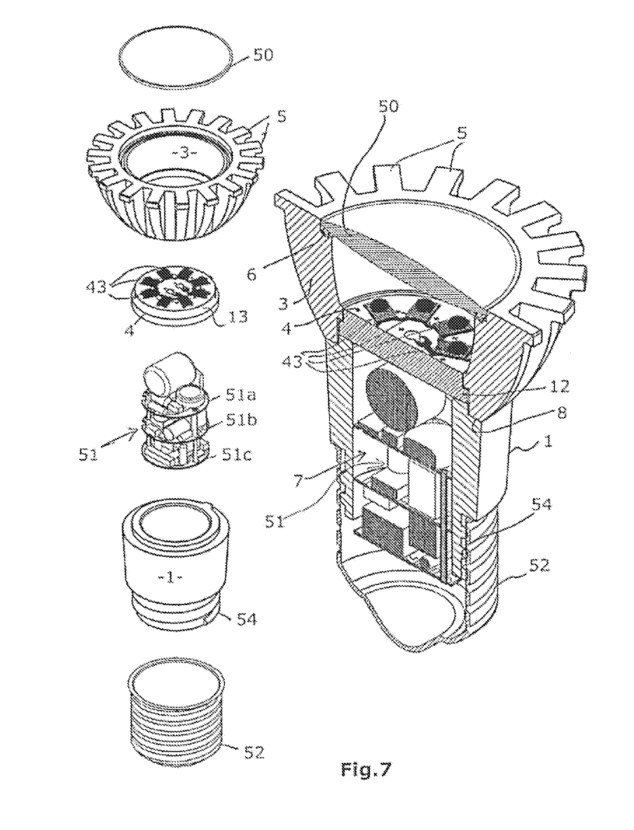

FIG. 7 shows another exemplary embodiment,

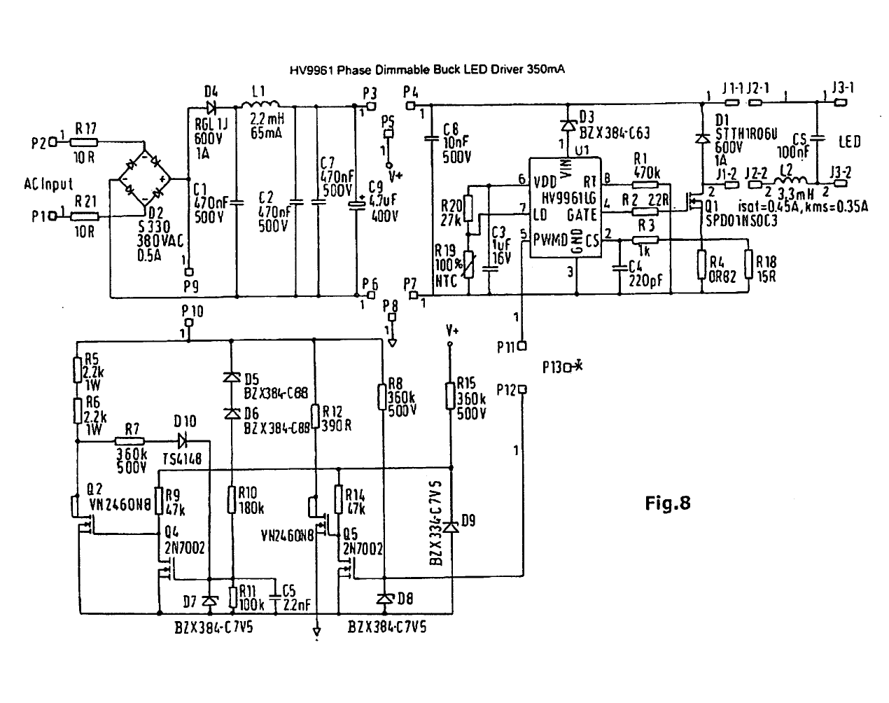

FIGS. 8-13c show detailed electronic circuits of the exemplary embodiment according to FIG. 7, and

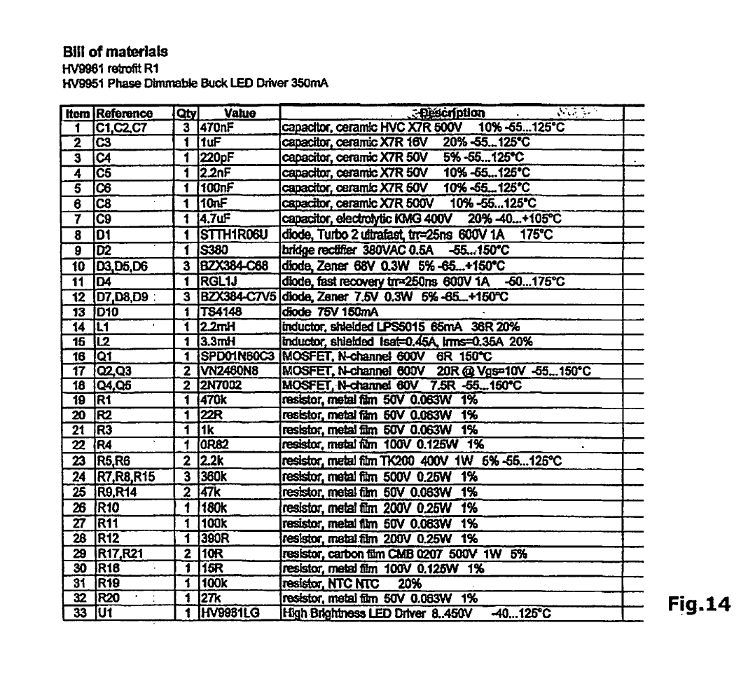

FIG. 14 shows a table with the components used in the electronic circuits of the exemplary embodiment according to FIG. 14.

FIGS. 1 to 3 and 6 show a socket GU10 lamp according to the invention, consisting of a base part 1 with a current feed 2, a lamp shade 3 and a stick-on ceramic mounting substrate 4. The lamp shown in FIG. 6 does not have a lamp shade. Otherwise it is designed to be identical to the lamp in FIG. 1.

In this example, the mounting substrate 4 is a substrate body and/or mounting disk for the LED and the driver 17. In this example, it is made of gray AIN, which has a high thermal conductivity, and the lamp shade 3 is made of a ruby-colored aluminum oxide doped with chromium oxide. The mounting substrate 4 is not visible here. The lamp body and/or lamp shade 3 is/are sealed with a glass disk (not shown) at the upper end of the lamp shade 3.

Sintered metallized areas 15 are arranged on the surface of the ceramic body 4 for soldering the LED(s). These sintered metallized areas 15 form conductors and thus form a circuit board. The diodes on the metallized areas 15 are not shown for reasons of simplicity. The drivers 17 are shown only schematically. In the embodiment shown here, the drivers 17 are not arranged on the sintered metallized areas 14 or 15 but instead are arranged on the mounting substrate 4. With further miniaturization of the LEDs (even 2×2 mm is possible today), the driver may also be mounted directly on the metallized areas 15. Bushings 16 (see FIG. 3) or plug elements (2, 11) for the electric terminal wires are arranged in the mounting substrate 4. These connecting wires are electrically connected to the drivers 17, and the drivers 17 are electrically connected to the metallized areas 15. Any number of metallized areas 15 may be arranged on the mounting substrate 4.

The mounting substrate 4 has a radial indentation 13 on the peripheral surface facing the metallized area 15 for better fixation.

In one preferred embodiment, the lamp is formed as a module from three ceramic parts, namely a base part 1 with a current feed 2, a mounting substrate 4 and/or mounting disk and a lamp shade 3. For example, electric terminal wires (not shown in the figure) are guided into the base part 1 through the current feed 2, 11 and within the base part 1 up to the drivers 17 and from there to the LEDs. The mounting substrate 4 is made of a ceramic, preferably with heat high dissipation. The LED is soldered to the conductors on the mounting substrate 4. The lamp shade 3 is also preferably made of a ceramic with cooling ribs 5 on its outside surface. The cooling ribs 5 extend in the longitudinal direction of the lamp shade 3.

In this description, a mounting disk is shown for the mounting substrate 4. “Mounting substrate” is the general term because the mounting substrate is only preferably a mounting disk. The mounting substrate may also be designed so it is not disk-shaped. Otherwise the two terms describe the same object.

For better fastening of the lamp shade 3 on the base part 1, it has a shoulder 8 on its inside surface, with which the lamp shade 3 sits on a corresponding shoulder or indentation 13 on the mounting substrate 4. The lower end of the lamp shade 3 extends around the mounting substrate 4 and the upper end 12 of the base part 1. The mounting substrate 4 is arranged between the lamp shade 3 and the base part 1 in such a way that it is not visible from the outside. The upper end of the lamp shade 3 facing away from the mounting disk 4 has an inner shoulder 6 for receiving a glass disk. The base part 1 is preferably cylindrical in shape with an inner cavity 7. This saves on material.

The lamp thus consists of a base part 1, a mounting disk 4 and a lamp shade 3 surrounding the LED. The light source is attached to the mounting substrate 4.

The base part 1 may also be equipped with corresponding plug receptacles or with a thread for screwing in holders to establish plug connections, or in the case of bases equipped with terminal poles, it may also be equipped with a lamp base.

The lamp shade 3 has cooling ribs 5 evenly distributed on its circumference, so that the outline of the lamp shade 3 at its opening looks like a gear wheel. The cooling ribs 5 are advantageous with high-power LEDs in particular in order to dissipate the resulting heat to the ambient air. Their cross section may also assume any other possible shape, such as half-round or half-elliptical, for example. In the case of LEDs with low heat losses, the shade may also be smooth. The shade may also have different shapes, for example, it may oval or polygonal.

The base part 1 may also be designed in one piece with the mounting substrate 4, as shown in FIG. 2.

FIG. 6 shows an embodiment of the lamp according to FIG. 1 without the lamp shade 3. This shadeless variant is advantageous because heat and/or sunlight can influence the driver temperature directly (unshaded), and the LEDs may be reregulated in a very short period of time due to this change in temperature. The same reference numerals in FIGS. 1, 2 and 6 also show the same object.

FIG. 4 shows an array of nine diode substrates 20, which consist of the ceramic cooling bodies described in WO 2007/107601 A2 (see description introduction) with sintered metallized areas as conductors. Six diodes and/or LEDs 23 are mounted on each diode substrate 20 (shown only schematically) and are also electrically connected to one another via the metallized areas (not shown). The diode substrates 20 have fins 27 for cooling.

FIG. 4 shows square diode substrates 20, but any other shape may also be used. The individual diode substrates 20 are installed or suspended in a metal frame 21 or may also serve as the current feed for the LEDs 23 at the same time. The array of the diode substrates 20 serves to provide large-area illumination but can also be used for spot illumination. The diode substrates 20 are therefore secured at different angles in the metal frame 21 to produce a focused light.

For example, a parabolic arrangement with a focal point of light is formed by folding up the corners 22. The array may also be planar for illumination of an area or may be bent for spot illumination.

The driver of the control of the LEDs is preferably also arranged on at least one diode substrate, preferably on each diode substrate 20 at the same time. This is not shown in the figures. The sintered metallized areas are designed here as conductors on which the LEDs are arranged.

FIGS. 5a, 5b show a ceramic diode substrate 40 in a view from above (FIG. 5a) and in a sectional view (FIG. 5b), consisting of a ceramic substrate body 32, which is provided in one piece, having heat-dissipating ceramic cooing elements 37, shown here in the form of fins. Sintered metallized areas 41 are applied to the surface 33 of the substrate body 32, so that the diode substrate 40 is a circuit board. LEDs 43 are attached to the diode substrate 40 and are soldered to the metallized areas 41. For a current-conducting and/or mechanical connection of two or more diode substrates 40 to form an array, the diode substrates 40 have plugs and/or sockets as connecting elements, with which the diode substrates 40 are connected directly or indirectly to one another.

In addition to the LEDs, their drivers are also arranged on the diode substrates 40 and are wired to the LEDs accordingly.

In another variant, the plugs are pins 36, in particular according to the GU 5.3 standard, and the sockets are adjusted to the pins. FIG. 5 shows an embodiment having only plugs, which consisting of pins 36 here. These pins 36, namely two for each plug, are arranged on the edge area of the diode substrate 40, such that the plugs 36 are situated on opposite sides of the diode substrate 40. A separate connecting element 38 is used here for connecting two diode substrates 40. In the variant shown here, this connecting element 38 is a rectangular or square-shaped plate with through-holes 44. The pins 36 are inserted into these holes 44 on the diode substrate 40, establishing an electrical contact. Each connecting element 38 has four holes 44. Two holes 44 are electrically connected to one another on the connecting element 38.

For fastening the diode substrates 40 in a frame, they have a strip 34 without metallized areas 41 on at least one edge and are without LEDs 43 and drivers. This strip 34 thus forms a ceramic spring for fastening on a frame or on a rail. At least two rails then form the frame.

The strip 34 preferably has at least one recess for fastening, preferably using a screw.

FIG. 7 shows in a sectional view and in an exploded diagram an alternative preferred embodiment of a lamp according to the invention. This lamp resembles the lamp in FIG. 1 and is provided for the lamp base E27. This lamp consists of six parts and/or units, namely a metallic threaded socket 52, a ceramic base part 1, an electronic module 51 as a driver for controlling the LEDs 43, a ceramic mounting substrate 4, a ceramic lamp shade 3 with cooling ribs 5 and a glass disk 50.

The base part 1 is designed as a hollow cylindrical body that is open on both ends and is the central substrate body of the lamp. The base part 1 has an outer thread 54, which is indented radially toward the outside wall of the base part 1 on its end which faces away from the lamp shade 3. The threaded socket 52 with its inside thread is screwed onto this outside thread 54. This threaded socket 52 is designed according to the E27 standard and is made of metal.

The electronic module 51, which contains the driver, is inserted into the base part 1. The electric connection of the electronic module 51 is indicated only for a better overview. The electronic module 51 is electrically connected to the LEDs 43 on the mounting substrate 4. To this end, the mounting substrate 4 has two holes through which the electrical connection leads from the electronic module 51 to the LEDs.

The ceramic mounting substrate 4 is glued to the base part 1. The mounting substrate 4 is the substrate body and/or the mounting disk for the LEDs 43 and is preferably made of gray AIN with a high thermal conductivity, and the lamp shade 3 is made of ruby-colored aluminum oxide doped with chromium oxide. The mounting substrate 4 is not visible from the outside. The lamp shade 3 is sealed with a glass disk 50 at the upper end of the lamp shade 3.

On the surface of the ceramic substrate 4, sintered metallized areas are arranged for soldering the LEDs 43. These sintered metallized areas form conductors and therefore form a circuit board. The drivers are arranged on three circuit boards 51a, 51b, 51c, which are in turn arranged vertically one above the other in the electronic module 51. If there is enough space, the drivers are preferably arranged on the sintered metallized areas or on the plain mounting substrate 4. The drivers are electrically connected to the LED. Alternatively, the LEDs and the substrate body, i.e., the ceramic substrate 4, may be electrically connected to one another via an electrically conductive intermediate layer.

Any number of metallized areas may be arranged on the mounting substrate 4. In the embodiment in FIG. 7, however, the drivers are arranged in the electronic module 51, which is situated in the cavity 7 in the base part 1. The electronic module 51 is preferably secured in the base part 1 with a thermally conductive, electrically insulating casting compound.

The mounting substrate 4 may also be designed so it is not disk-shaped. The mounting substrate 4 has a radial indentation 13 for better fixation. The mounting substrate 4 is made of a ceramic, preferably with a high heat dissipation property. The LED is soldered to the conductors on the mounting substrate 4.

The lamp shade 3 preferably is made of a ceramic with cooling ribs 5 on its outside surface. The cooling ribs 5 extend in the longitudinal direction of the lamp shade 3.

For better mounting of the lamp shade on the base part 1, it has a shoulder 8 on its inside surface, with which the lamp shade 3 sits on a corresponding shoulder or indentation 13 on the mounting substrate 4. The lower end of the lamp shade 3 extends around the mounting substrate 4 and the upper end 12 of the base part 1. The base part 1 is preferably designed to be cylindrical with an inner cavity 7. This saves on material and creates space for the electronic module 51.

The base part 1 may also be equipped as a plug for establishing plug connections with corresponding sockets or with threads for screwing them into holders or in the case of sockets with terminal poles, into lamp bases.

The lamp shade 3 has cooling ribs 5 running in the longitudinal direction of the lamp, uniformly distributed around its circumference, so that the outline of the lamp shade 3 looks like a gearwheel at its opening. The cooling ribs 5 are advantageous in particular in the case of high-power LEDs to dissipate the resulting heat to the ambient air. Their cross section may also assume any other possible shape such as half-round or half-elliptical, for example. In the case of LEDs with low heat losses, the shade may also be smooth. The shade may also have different shapes, for example, oval or polygonal.

Electrical insulation is provided due to the use of ceramic housing components and circuit board components, and the driver can be connected directly without galvanic separation. Because of the thermal heat-conducting properties of the ceramic in conjunction with a heat-conducting casting compound and the spatially compact sandwich design (see FIG. 7), this yields a very good overall heat distribution in the interior of the base and/or in the interior of the base part 1. The power loss by the driver itself and the heat generated by the LEDs both reach the electronics with a slight time lag, so then the power supply to the LEDs is linearly down-regulated, so that a freely preselected maximum temperature of the overall system is not exceeded. Thus the driver circuit itself as well as the LEDs are protected from overheating. The better the cooling, the brighter are the LEDs and vice-versa. A thermal overload is largely prevented. In addition, the entire circuit can be dimmed manually with commercial phase control dimmers over a wide range.

FIG. 8 shows the complete electronic circuit of the drivers, listing the components used in FIG. 14.

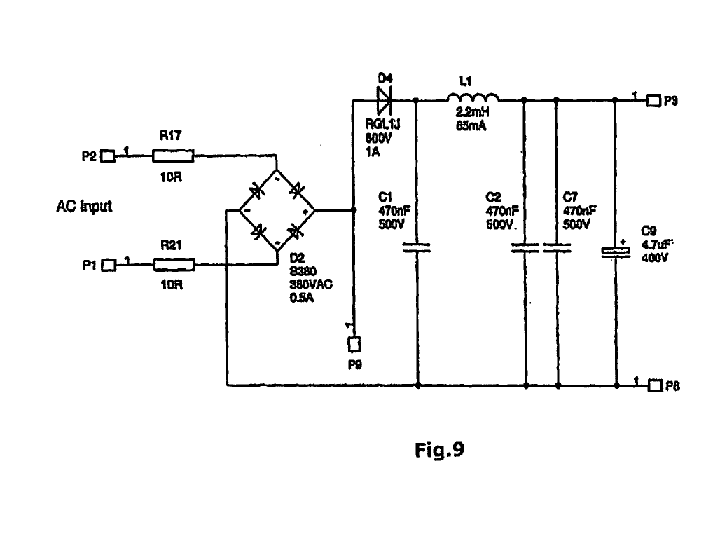

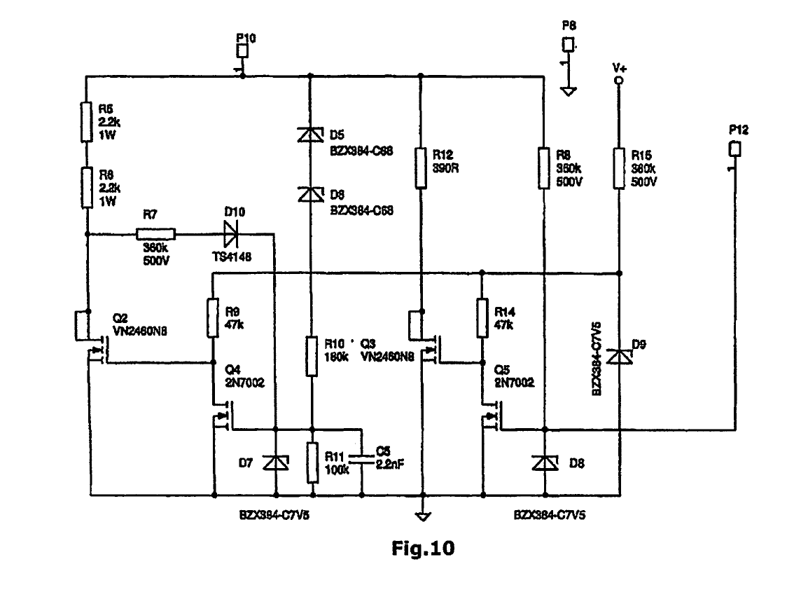

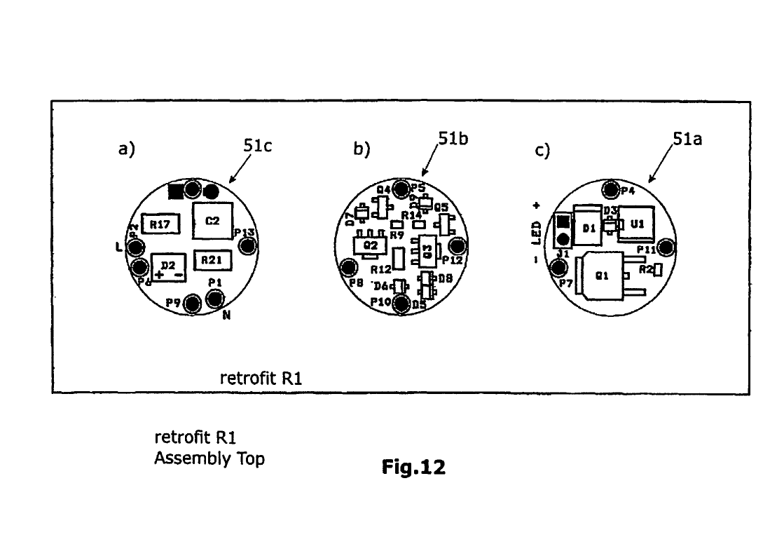

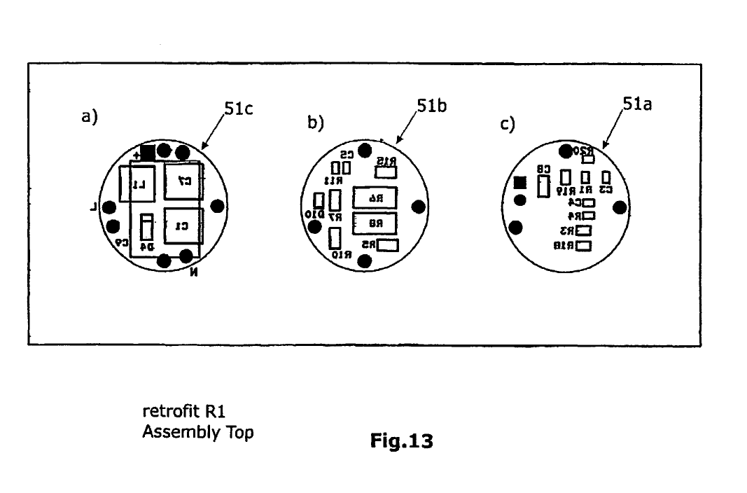

FIG. 9 shows the electronic circuit of the electronic module 51c (see FIG. 7). FIGS. 12a and 13a show a schematic view of the electronic module 51c from above and below. The electronic module 51c is responsible for the connection to the 230 volt network and has a bridge rectifier with diodes D2. The two resistors R17 and R21 are connected upstream from the bridge rectifier for limiting the input current in order to prevent a short circuit in the event of discharged capacitors. The resistors R17 and R21 also serve as overvoltage protection for network voltages up to 500 volt. The bridge of the bridge rectifier is equipped with smoothing capacitors C1, C2 and C7, which are designed as ceramic capacitors and have a lifetime of up to 500,000 hours of operation. A filtering effect is achieved with the capacitors and the coil L1, to short-circuit high parasitic frequencies. The capacitor C9 is an aluminum electrolyte capacitor for dimming the dc voltage generated.

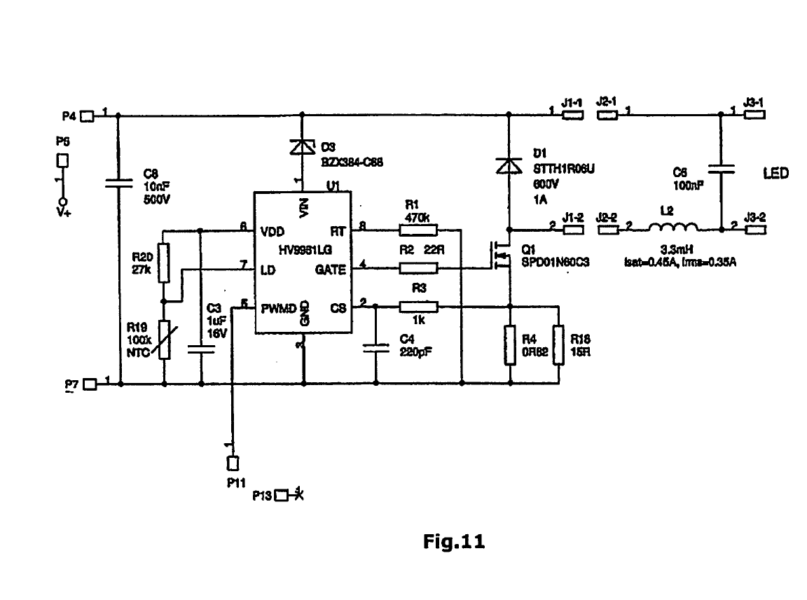

FIG. 10 shows the electronic circuit of the electronic module 51b (see FIG. 7). FIGS. 12b and 13b each show a schematic view of the electronic module 51b from above and below. The electronic module 51b is a dimmer circuit for phase control dimming. The dimmer circuit uses voltage dividers, diodes and MOS field effect transistors. The dimmer circuit simulates an ohmic load in the range of approx. 10 watts, so that the power applied to the dimmers is sufficient to operate them.

FIG. 11 shows the electronic circuit of the electronic module 51a (see FIG. 7). FIGS. 12c and 13c each show a schematic view of the electronic module 51a from above and below. The electronic module 51a has an integrated circuit of the HV9961LG type to control the LED current on the output end. A temperature-dependent resistor (NTC) R19 is arranged at the input 7 of the integrated circuit, generating a control signal for the integrated circuit for control of the LED as a function of temperature. The temperature-dependent dimming takes place using pulse width modulation. The integrated circuit HV9961 LG is designed for temperatures from −55° C. to +125° C. with a power class of 10 watts for the military temperature range to achieve a long service life. The integrated circuit generates a power supply voltage for the LED, which is reduced in comparison with the line voltage, such that the remaining voltage is dissipated as heat. At the output end, the integrated circuit is provided with a MOS field effect transistor Q1 and with a throttle coil L2 having an inductance of 3 millihenries. Up to eight LEDs can be operated with the control circuit according to FIG. 11.

The advantages of the invention thus include the following, among others:

1. Optimal protective insulation due to the use of ceramic materials.

2. Optimal dissipation of heat due to the use of ceramic materials.

3. Attractive design due to the use of ceramic materials as the housing.

4. Protection against overheating due to installed electronic module 51 and/or NTC thermally coupled by casting.

1.-15. (canceled)

16. An LED lamp having at least one LED arranged on a ceramic substrate body and connected to it in a thermally conducting manner and having an electronic driver connected electrically to the LED for controlling the power and supplying power to it, wherein the driver is connected to the substrate body in a thermally conducting manner.

17. An LED lamp according to claim 16, wherein the driver is designed to regulate the power supply to the LED as a function of the temperature of the substrate body.

18. An LED lamp according to claim 16, wherein the driver is cast together with the substrate body in a thermally conductive casting compound.

19. An LED lamp according to claim 16, wherein the first circuit board has as the preliminary stage a bridge rectifier circuit having smoothing capacitors and having a filter circuit in the bridge branch.

20. An LED lamp according to claim 19, wherein the substrate body has sintered metallized areas on its surface with which the LED and the substrate body are electrically connected either directly or by way of an electrically conductive intermediate layer.

21. An LED lamp according to claim 20, wherein the driver is arranged on the side of the substrate body opposite the LED.

22. An LED lamp according to claim 21, wherein the driver has at least two circuit boards stacked one above the other.

23. An LED lamp according to claim 22, wherein the substrate has three stacked circuit boards, the first circuit board forming a preliminary stage, the second circuit board forming a temperature-controlled dimmer stage and the third circuit board forming an output stage for the power supply to the LED.

24. An LED lamp according to claim 23, wherein the first circuit board has as the preliminary stage a bridge rectifier circuit with smoothing capacitors and a filter circuit in the bridge branch.

25. An LED lamp according to claim 24, wherein at least one of the smoothing capacitors comprises an aluminum electrolyte capacitor having a capacitance in the range between approximately 1 and 10 microfarads.

26. An LED lamp according to claim 23, wherein the second circuit board has at least one ohmic voltage divider to simulate an ohmic load in the range of approximately 5-20 watts and preferably approximately 10 watts for the LED dimmer.

27. An LED lamp according to claim 23, wherein the third circuit board has a temperature-dependent resistor which supplies the LED with a reduced power, depending on the temperature in comparison with the line voltage.

28. An LED lamp according to claim 27, wherein for control of the LED current, the third circuit board has an integrated circuit which is designed for a temperature range between −55° C. and +125° C. and is connected at its input to the temperature-dependent resistor.

29. An LED lamp according to claim 28, wherein a MOS field effect transistor or a choke coil is arranged between the output of the integrated circuit and the LED.

30. The LED lamp according to claim 29, wherein the substrate for controlling the power to the LED has a circuit for phase control.
